(19) United States
(12) Patent Application Publication
(10) Pub. No.: US 2021/0134271 A1
(43) Pub. Date: May 6, 2021

(54) LOW-POWER SPEECH RECOGNITION DEVICE AND METHOD OF OPERATING SAME

(71) Applicant: LG ELECTRONICS INC., Seoul (KR)

(72) Inventors: Hyukgeun CHA, Seoul (KR); Jungwoo LEE, Seoul (KR)

(73) Assignee: LG ELECTRONICS INC., Seoul (KR)

(21) Appl. No.: 16/870,844

(22) Filed: May 8, 2020

(30) Foreign Application Priority Data
Oct. 31, 2019 (KR) 10-2019-0138058

(51) Int. Cl. G10L 15/08; G10L 15/16; G06F 1/3287; G06F 1/3231; G06N 3/04; G06N 3/08

(52) U.S. Cl. CPC G10L 15/08; G10L 15/16; G06F 1/3287; G10L 2015/088; G06N 3/04; G06N 3/08; G06F 1/3231

(57) ABSTRACT

A low-power speech recognition device based on artificial intelligence and a method of operating the same are proposed. The method including: receiving an audio signal; storing the audio signal in a memory; detecting whether the audio signal is a speech signal spoken by a user; preprocessing, by an audio processor, noise and an echo in the audio signal stored in the memory, when the audio signal is the speech signal; determining, by the audio processor, whether the preprocessed audio signal contains an activation word; activating a processor for natural language processing, when the preprocessed audio signal contains the activation word; and performing, by the processor, natural language processing on the audio signal received after the audio signal containing the activation word. Accordingly, the device uses an artificial intelligence technology while power consumption is reduced, thereby satisfying industrial and user demands for producing and using low-power products.

### CROSS REFERENCE TO RELATED APPLICATION

Pursuant to 35 U.S.C. § 119(a), this application claims the benefit of earlier filing date and right of priority to Korean Patent Application No. 10-2019-0138058, filed on Oct. 31, 2019, the contents of which are hereby incorporated by reference herein in its entirety.

### BACKGROUND OF THE INVENTION

### Field of the Invention

Various embodiments of the present disclosure relate to a low-power speech recognition device based on artificial intelligence and a method of operating the low-power speech recognition device.

### Description of the Related Art

For humans, talking by voice is perceived as the most natural and simple way to exchange information. Reflecting this, recently, in robots, vehicles, and various home appliances including refrigerators, washing machines, vacuum cleaners, and the like, a speech recognition device which recognizes talker's speech, understands the talker's intent, and is controlled according thereto has been widely used.

In order to talk with an electronic device by voice, human speech needs to be converted into a code that the electronic device is capable of processing. The speech recognition device is an apparatus for extracting linguistic information from acoustic information contained in the speech and converting a result of extraction into a code that a machine is capable of understanding and responding to.

Speech recognition based on an artificial intelligence technology has been attempted to increase accuracy of speech recognition, but the artificial intelligence technology uses a large amount of memory, requires computer power for numerous calculations, so power consumption may be significant.

The foregoing is intended merely to aid in the understanding of the background of the present disclosure, and is not intended to mean that the present disclosure falls within the purview of the related art that is already known to those skilled in the art.

### SUMMARY OF THE INVENTION

Reducing power consumption in home appliances or mobile products is essential.

Various embodiments of the present disclosure may provide a hardware device that reduces power consumption in a device performing speech recognition by using an artificial intelligence technology.

Various embodiments of the present disclosure may provide a method of recognizing speech by using the above-described hardware device while reducing power consumption.

Various embodiments of the present disclosure may provide an electronic device including the above-described hardware device, the electronic device being capable of reducing power consumption according to the above-described method.

It is to be understood that technical problems to be solved by the present disclosure are not limited to the aforementioned technical problems and other technical problems which are not mentioned will be apparent from the following description to a person with an ordinary skill in the art to which the present disclosure pertains.

According to various embodiments of the present disclosure, a speech recognition device comprises an MIC interface configured to receive an audio signal, a speech detection unit configured to detect whether the audio signal is a speech signal spoken by a user, a memory configured to store the audio signal, a processor configured to perform natural language processing and an audio processor, wherein the audio processor is configured to receive a speech detection signal from the speech detection unit, preprocess the audio signal stored in the memory, determine whether the preprocessed audio signal contains an activation word, generate a signal for activating the processor, when the audio signal contains the activation word and transmit, to the processor, the audio signal that is input after the audio signal containing the activation word.

According to various embodiments of the present disclosure, an electronic device comprises a user interface configured to receive a command from a user and providing operation information to the user, a speech recognition device configured to recognize a command from speech of the user, a driving unit configured to perform mechanical and electrical operations to operate the electronic device, a processor operatively connected to the user interface, the speech recognition device, and the driving unit and a memory operatively connected to the processor and the speech recognition device, wherein the speech recognition device is an above speech recognition device and the memory is configured to store a program for preprocessing an audio signal and a program for recognizing an activation word, the programs being used in the speech recognition device.

According to various embodiments of the present disclosure, a method of operating a speech recognition device comprises receiving an audio signal, storing the audio signal in a memory, detecting whether the audio signal is a speech signal spoken by a user, when the audio signal is the speech signal spoken by the user, preprocessing, by an audio processor, noise and an echo in the audio signal stored in the memory, determining, by the audio processor, whether the preprocessed audio signal contains an activation word, activating a processor for natural language processing, when the preprocessed audio signal contains the activation word and performing, by the processor, natural language processing on the audio signal that is received after the audio signal containing the activation word.

According to various embodiments, the speech recognition device uses an artificial intelligence technology while power consumption is reduced, thereby satisfying industrial and user demands for producing and using low-power products.

Effects that may be obtained from the present disclosure will not be limited to only the above described effects. In addition, other effects which are not described herein will become apparent to those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating an example of a fully-connected artificial neural network structure;

FIG. 2 is a diagram illustrating an example of a convolutional neural network (CNN) structure that is a type of deep neural network;

FIG. 3 is a block diagram illustrating a configuration of an electronic device including a speech recognition device;

FIG. 4 is a block diagram illustrating a speech recognition device according to various embodiments;

FIG. 5 is a flowchart illustrating a process in which a speech recognition device recognizes speech, according to various embodiments; and

FIG. 6 is a flowchart illustrating a process in which a speech recognition device loads a learning model from an external memory, according to various embodiments,

wherein regarding description of the drawings, the same or similar elements are denoted by the same or similar reference numerals.

### DETAILED DESCRIPTION OF THE INVENTION

Hereinafter, embodiments described in the specification will be described in detail with reference to the accompanying drawings. Regardless of reference numerals, the same or similar elements are denoted by the same reference numerals, and a duplicated description thereof will be omitted.

The suffix “module” or “unit” for the element used in the following description is merely intended to facilitate description of the specification, and the suffix itself does not have a meaning or function distinguished from others. Further, the term “module” or “unit” may refer to a software element or a hardware element such as a field programmable gate array (FPGA), and an application specific integrated circuit (ASIC), and performs particular functions. However, the term “unit” or “module” is not limited to software or hardware. The term “unit” or “module” may be formed so as to be in an addressable storage medium, or may be formed so as to operate one or more processors. Thus, for example, the term “unit” or “module” may refer to elements such as software elements, object-oriented software elements, class elements, and task elements, and may include processes, functions, attributes, procedures, subroutines, segments of program code, drivers, firmware, micro codes, circuits, data, a database, data structures, tables, arrays, and variables. A function provided in the elements and “units” or “modules” may be associated with the smaller number of elements and “units” or “modules”, or may be divided into additional elements and “units” or “modules”.

The steps of the method or algorithm described in association with several embodiments of the present disclosure may be implemented directly into a hardware module, a software module, or a combination thereof, which are executed by a processor. A software module may be provided in RAM, flash memory, ROM, EPROM, EEPROM, a register, a hard disk, a removable disk, CD-ROM, or any other types of recording medium known in the art. An exemplary storage medium is coupled to the processor such that the processor reads information from the recording medium and writes information to the storage medium. Alternatively, the recording medium may be integrated with the processor. The processor and the recording medium may be provided in an application-specific integrated circuit (ASIC). The ASIC may be provided in a user terminal.

In describing the embodiments described in the specification, if it is decided that the detailed description of the known art related to the present disclosure makes the subject matter of the present disclosure unclear, the detailed description will be omitted. In addition, the accompanying drawings are only to easily understand an embodiment described in the specification. It is to be understood that the technical idea described in the specification is not limited by the accompanying drawings, but includes all modifications, equivalents, and substitutions included in the spirit and the scope of the present disclosure.

Terms including ordinal numbers, such as “first”, “second”, etc. can be used to describe various elements, but the elements are not to be construed as being limited to the terms. The terms are only used to differentiate one element from other elements.

It will be understood that when an element is referred to as being “coupled” or “connected” to another element, it can be directly coupled or connected to the other element or intervening elements may be present therebetween. In contrast, it will be understood that when an element is referred to as being “directly coupled” or “directly connected” to another element, there are no intervening elements present.

Artificial intelligence refers to the field of researching artificial intelligence or the methodology to create the same, and machine learning refers to the field of defining various problems in the field of artificial intelligence and researching the methodology for solving the problems. Machine learning is defined as an algorithm that improves the performance of an operation by performing a consistent experience for the operation.

An artificial neural network (ANN) is a model used in machine learning, configured with artificial neurons (nodes) constituting a network in a synapse coupling, and means a model with problem solving ability. The artificial neural network may be defined by a connection pattern between neurons of other layers, a learning process of updating a model parameter, and an activation function generating an output value.

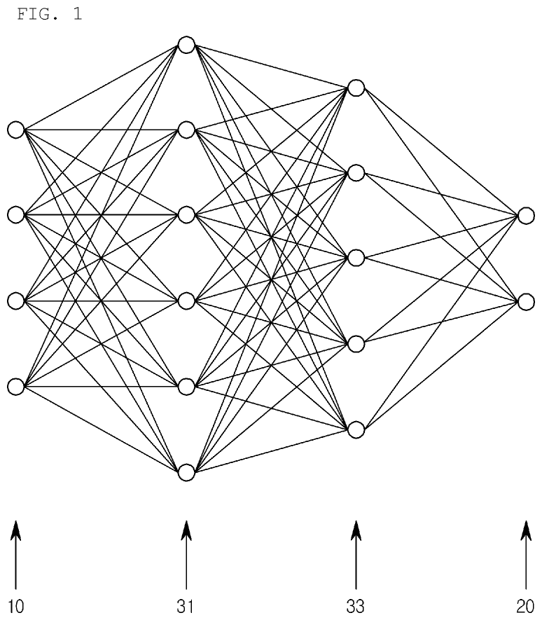

FIG. 1 is a diagram illustrating an example of a fully-connected artificial neural network structure.

Referring to FIG. 1, the artificial neural network may include an input layer 10, an output layer 20, and selectively one or more hidden layers 31 and 33. Each layer may include one or more nodes corresponding to neurons of the neural network, and the artificial neural network may include a synapse connecting a node of one layer and a node of another layer. In the artificial neural network, the node may receive input signals that are input through the synapse, and may generate an output value on the basis of an activation function with respect to a weight for each of the input signals and a bias. The output value of each node may serve as an input signal to the subsequent layer through the synapse. An artificial neural network in which all nodes of one layer are connected to all nodes of the subsequent layer through synapses may be referred to as a fully-connected artificial neural network.

The model parameter of the artificial neural network refers to a parameter determined through learning, and may include a weight of a synapse connection, a bias of a neuron, etc. In addition, a hyperparameter refers to a parameter that has to be set before performing learning in a machine learning algorithm, and may include a learning rate, a number of repetition times, a size of a mini-batch, an initialization function, etc.

Machine learning, among artificial neural networks, employed in a deep neural network (DNN) including a plurality of hidden layers, is referred to as deep learning, and the deep learning is a part of the machine learning. Hereinafter, machine learning may be used as including deep learning.

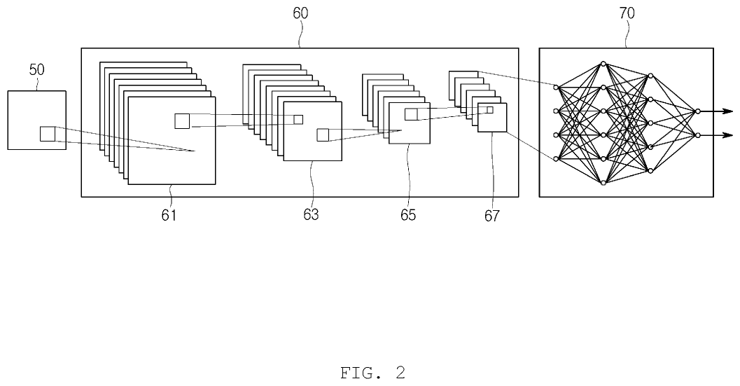

FIG. 2 is a diagram illustrating an example of a convolutional neural network (CNN) structure that is a type of deep neural network.

In identifying structural space data such as images, videos, and text strings, the convolutional neural network structure shown in FIG. 2 may be more effective. The convolutional neural network maintains spatial information of an image and effectively recognizes a feature with a nearby image simultaneously.

Referring to FIG. 2, the convolutional neural network includes a feature extraction layer 60 and a classification layer 70. The feature extraction layer 60 extracts a feature of an image by performing convolution on spatially nearby pieces of the image.

The feature extraction layer 60 may be constructed in the form of multiple convolutional layers 61 and 65 and pooling layers 63 and 67 stacked. The convolutional layers 61 and 65 may be results of applying a filter to input data and then applying an activation function. The convolutional layers 61 and 65 may include multiple channels, and the channels may be results of applying different filters and/or different activation functions. The result of the convolutional layers 61 and 65 may be a feature map. The feature map may be data in the form of a two-dimensional matrix. The pooling layers 63 and 67 may be used to receive output data of the convolutional layers 61 and 65, in other words, the feature map so as to reduce the size of the output data or to emphasis particular data. The pooling layers 63 and 67 may generate output data by applying a function of the following: max pooling in which the maximum value is selected from part of the output data of the convolutional layers 61 and 65; average pooling in which the average value is selected; and min pooling in which the minimum value is selected.

The feature maps generated through a series of the convolutional layers and the pooling layers may become smaller little by little. The final feature map generated through the last convolutional layer and pooling layer may be converted into a one-dimensional form and may be input to the classification layer 70. The classification layer 70 may be the fully-connected artificial neural network structure shown in FIG. 1. The number of input nodes of the classification layer 70 is equal to a value obtained by multiplying the number of elements in the matrix of the final feature map and the number of channels.

In addition to the above-described convolutional neural network, a recurrent neural network (RNN), a long short-term memory (LSTM) network, gated recurrent units (GRUs), or the like may be used as the deep neural network structure.

An objective of performing learning for an artificial neural network is to determine a model parameter that minimizes a loss function. The loss function may be used as an index for determining an optimum model parameter in a learning process of the artificial neural network. In the case of the fully-connected artificial neural network, a weight of each synapse may be determined by learning. In the case of the convolutional neural network, a filter of the convolutional layer for extracting the feature map may be determined by learning.

Machine learning may be classified into supervised learning, unsupervised learning, and reinforcement learning according to a learning method.

Supervised learning may refer to a method of performing learning for an artificial neural network where a label related to learning data is provided, and the label may refer to a right answer (or result value) that has to be estimated by the artificial neural network when the learning data is input to the artificial neural network. Unsupervised learning may refer to a method of performing learning for an artificial neural network where a label related to learning data is not provided. Reinforcement learning may refer to a learning method performing learning so as to select, by an agent defined under a certain environment, an action or an order thereof such that an accumulated reward in each state is maximized.

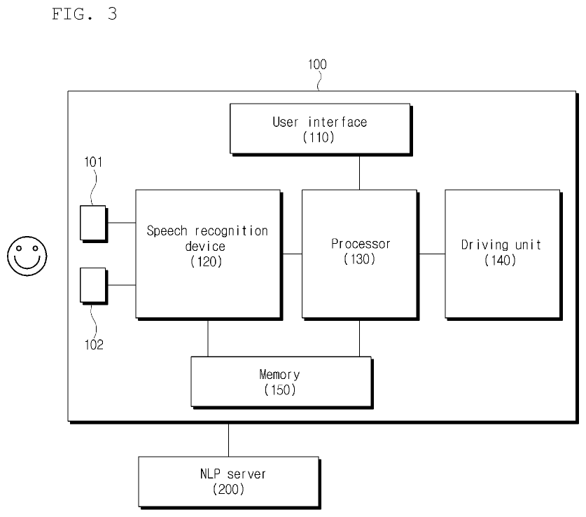

FIG. 3 is a block diagram illustrating a configuration of an electronic device 100 including a speech recognition device 120.

The electronic device 100 shown in FIG. 3 may be a mobile electronic device, such as a mobile phone, a smart phone, a laptop computer, an artificial intelligence device for digital broadcasting, a personal digital assistant (PDA), a portable multimedia player (PMP), a navigation device, a slate PC, a tablet PC, Ultrabook, a wearable device (for example, a watch-type artificial intelligence device (smartwatch), a glass-type artificial intelligence device (smart glass), a head-mounted display (HMD)), etc.; or may be a fixed electronic device such as a refrigerator, washing machine, a smart TV, a desktop computer, a digital signage, etc. In addition, the electronic device 100 may be a fixed or movable robot.

The configuration of the electronic device 100 shown in FIG. 3 is an embodiment, and each element may be constructed into one chip, component, or electronic circuit, or into a combination of chips, components, or electronic circuits. According to another embodiment, part of the elements shown in FIG. 3 may be divided into several elements and constructed into different chips, components, or electronic circuits. Alternatively, several elements may be combined to be constructed into one chip, component, or electronic circuit. In addition, according to another embodiment, part of the elements shown in FIG. 3 may be omitted, or an element not shown in FIG. 3 may be added.

Referring to FIG. 3, the electronic device 100 according to various embodiments may include a user interface 110, a speech recognition device 120, a processor 130, a driving unit 140, a memory 150, and microphones 101 and 102.

The user interface 110 may include a display unit and an input/output unit, and may then receive a command from a user and may then display various types of operation information related to the user according to the input command. According to an embodiment, in the case where the electronic device 100 is a home appliance such as a washing machine, a refrigerator, a vacuum cleaner, or a tumble dryer, the user interface 110 may include a control panel that is capable of receiving setting information and a command related to the operation of the electronic device 100.

The memory 150 may include a volatile memory or a non-volatile memory. Examples of the non-volatile memory include read-only memory (ROM), a programmable ROM (PROM), an electrically programmable ROM (EPROM), an electrically erasable and programmable ROM (EEPROM), flash memory, phase-change RAM (PRAM), magnetic RAM (MRAM), resistive RAM (RRAM), ferroelectric RAM (FRAM), etc. The volatile memory may include at least one of various memories, such as dynamic RAM (DRAM), static RAM (SRAM), synchronous DRAM (SDRAM), phase-change RAM (PRAM), magnetic RAM (MRAM), resistive RAM (RRAM), ferroelectric RAM (FeRAM), etc.

The speech recognition device 120 may recognize a user's speech, and may identify, from the speech, an intent word indicating setting information or a command related to the operation of the electronic device 100 to provide the intent word to the processor 130. The intent word recognized by the speech recognition device 120 may correspond to a button on the control panel of the user interface 110, which is capable of receiving the setting information and the command related to the operation of the electronic device 100.

Therefore, the user may set the electronic device 100 or may input the command to perform a particular operation, through the user interface 110 or the speech recognition device 120. According to an embodiment, the user presses a power button on the control panel or says “power” so that the state of the electronic device 100 is switched from a standby state to an activation state.

The driving unit 140 may perform, on the basis of control by the processor 130, various mechanical and electrical operations to operate the electronic device 100. According to an embodiment, the driving unit 140 may control a motor rotating a washing tank of a washing machine, a pump supplying water input into the washing tank, or a motor that drives to suction foreign substances in a vacuum cleaner. According to another embodiment, the driving unit 140 may control a motor for performing zoom-in and zoom-out operations of a device, such as a mobile phone, and a digital camera.

The processor 130 including at least one processor may receive the user's command input through the user interface 110 or the speech recognition device 120, and may control the driving unit 140 and other components within the electronic device 100 so as to perform an operation corresponding to the command.

In the above-described electronic device 100, the speech recognition device 120 that enables the user to control the electronic device 100 by speech has been gradually widely used. In addition, in order to increase the recognition rate of the speech recognition device 120, the use of the speech recognition device using the artificial neural network has been increased.

In the case of the speech recognition device using the artificial neural network, as a large amount of memory and computing power are used, power consumption may be high. Particularly, in the case where while being in a standby mode the electronic device 100 identifies speech by using the artificial neural network in order to find an activation word indicating that the command will be input, high power consumption may be caused compared to the conventional electronic device 100.

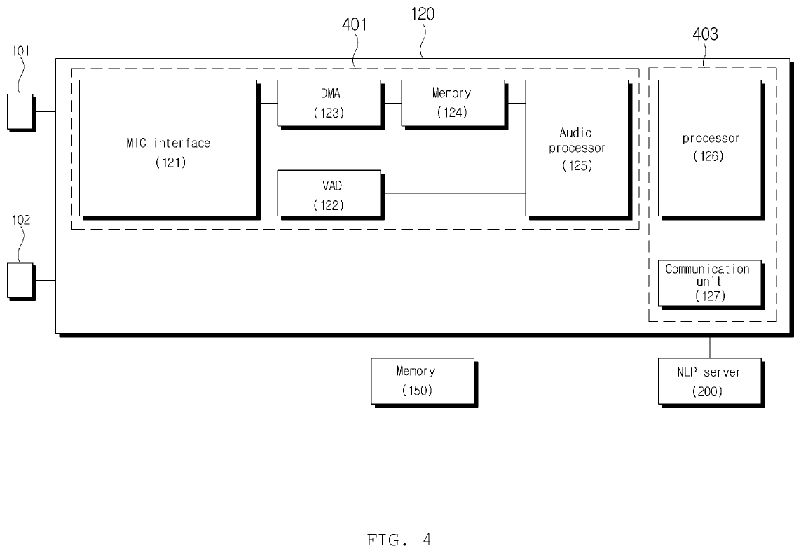

In order to minimize power consumption in the standby mode, the present disclosure provides a speech recognition device shown in FIG. 4.

FIG. 4 is a block diagram illustrating a speech recognition device 120 according to various embodiments.

The configuration of the speech recognition device 120 shown in FIG. 4 is an embodiment. All the elements may be provided in one chip or component, or may be constructed into an electronic circuit in which multiple chips or components including part of all the elements are combined. According to another embodiment, part of the elements shown in FIG. 4 may be divided into several elements and constructed into different chips, components, or electronic circuits. Alternatively, several elements may be combined to be constructed into one chip, component, or electronic circuit. In addition, according to another embodiment, part of the elements shown in FIG. 4 may be omitted, or an element not shown in FIG. 4 may be added.

Referring to FIG. 4, the speech recognition device 120 according to various embodiments may include an MIC interface 121, a speech detection (voice activity detection, VAD) unit 122, a direct memory access (DMA) unit 123, a local memory 124, an audio processor (digital signaling processor) 125, and a processor 126, and may further include a communication unit 127.

According to various embodiments, the MIC interface 121 may receive speech data from external microphones 101 and 102. According to an embodiment, the MIC interface 121 may receive speech data from the microphones 101 and 102 by using communication standards such as Inter-Integrated Circuit (I2S) or pulse-density modulation (PDM). Herein, the microphones 101 and 102 may include analog-to-digital converters (ADCs) so that the microphones 101 and 102 convert acquired analog speech data to digital signals and transmit the digital signals to the MIC interface 121 according to I2S or PDM communication standards. According to another embodiment, the MIC interface 121 may receive analog signals from the microphones 101 and 102, and uses an analog-to-digital converter (ADC) of the MIC interface 121 to convert the received analog signals to digital signals.

According to various embodiments, the speech detection unit 122 may detect speech activity and may transmit the same to the audio processor 125. Audio data that the MIC interface 121 receives may include speech spoken by the actual talker as well as ambient noise in general, so that the speech detection unit 122 determines whether the input audio data is caused by human speech, and may transmit a speech activity signal to the audio processor 125.

According to various embodiments, the DMA unit 123 may directly store, in the local memory 124, the speech data received by the MIC interface 121. According to an embodiment, the DMA unit 123 may store, in the local memory 124, the speech data, starting from the speech in which the speech activity is detected by the speech detection unit 122.

The local memory 124 may store the speech data received through the MIC interface 121. The stored speech data may be temporarily stored until being processed by the audio processor 125. The local memory 124 may be a static random-access memory (SRAM).

According to various embodiments, the audio processor 125 operates in a low-power mode or a sleep mode to minimize power consumption, and when speech is detected by the speech detection unit 122, the audio processor 125 is activated to perform an operation. The audio processor 125 may perform a speech preprocessing operation in which noise and an echo signal contained in the speech data are removed, and an activation word recognition operation for stating speech recognition.

When the activation word is recognized, the audio processor 125 transmits a signal for supplying power to the processor 126 for natural language processing. According to an embodiment, the audio processor 125 may additionally transmit, to the processor 126, a notification that the activation word is recognized.

The audio processor 125 may perform the preprocessing operation and the activation word recognition operation by using a small-size internal memory (for example, 128 KB of instruction RAM, or 128 KB of data RAM). According to an embodiment, the audio processor 125 may perform the preprocessing operation and the activation word recognition operation on the basis of the artificial intelligence technology based on the artificial neural network. In this case, due to insufficient size of the internal memory, it may be difficult to simultaneously execute a program for the preprocessing operation and a program for the activation word recognition operation. Therefore, when reception of the speech data is detected by the speech detection unit 122, the audio processor 125 loads the program for the preprocessing operation to perform preprocessing on the received speech data, and then loads the program for the activation word recognition operation to determine whether there is an activation word with respect to the preprocessed speech data. According to an embodiment, the program for the preprocessing operation and the program for the activation word recognition operation may be stored in the memory 150 of the electronic device 100 or in an external device.

According to an embodiment, when the activation word is recognized, or according to another embodiment, after transmitting the notification of activation word recognition to the processor 126, when a request for acquisition of the speech data to perform natural language processing is received from the processor 126, the audio processor 125 loads the program for the speech preprocessing operation again, and preprocesses the received speech data and transmits the resulting speech data to the processor 126.

According to various embodiments, the processor 126 is activated when the power is turned on, and may receive a notification that the activation word is recognized, from the audio processor 125. When the notification of activation word recognition is received, the processor 126 makes a request to the audio processor 125 for acquisition of the speech data so as to perform natural language processing. According to another embodiment, when the power is turned on, the processor 126 is activated and immediately goes into a state of waiting for the speech data to perform natural language processing.

The processor 126 may receive the preprocessed speech data from the audio processor 125, and may perform natural language processing on the received speech data. According to an embodiment, the processor 126 may perform natural language processing on the basis of the artificial intelligence technology.

According to an embodiment, the processor 126 may perform natural language processing by itself. Alternatively, according to another embodiment, the processor 126 may transmit the speech data to an external NLP server 200 through the communication unit 127, and may acquire a result of natural language processing from the external NLP server 200.

The processor 126 may acquire, as a result of natural language processing, information input by the user to set or operate the electronic device 100. According to an embodiment, the processor 126 may acquire, as a result of natural language processing, information, such as “wash”, “15 minutes”, “rinse”, and “three times”, which is set by the user pressing a button on the control panel.

The processor 126 may transmit the information acquired as a result of natural language processing, to the processor 130 of the electronic device 100.

The speech recognition device 120 shown in FIG. 4 may be implemented by one chip or required components placed on one substrate. In either case, in order to minimize power consumption of products including the speech recognition device 120, the audio processor 125 for the activation word recognition operation for starting speech recognition and the processor 126 for the natural language recognition operation may be set separately and located in different power domains. Further, until the activation word is recognized, hardware required for natural language processing may be operated in a low-power mode or may not be operated at all, and only the minimum hardware required for activation word recognition may be operated, thereby minimizing power consumption. Accordingly, in the case where the speech recognition device 120 shown in FIG. 4 is implemented by one chip, there may be separate terminals supplying power to the respective power domains.

Referring to FIG. 4, according to an embodiment, the MIC interface 121, the speech detection unit 122, the DMA unit 123, the local memory 124, and the audio processor 125 that are the minimum hardware required for activation word recognition may be placed in a power domain 401. The processor 126 and the communication unit 127 that may be used for natural language processing may be placed in another power domain 403. Further, the power domain 403 supplying power to hardware for natural language processing may not supply power until the activation word is recognized. Alternatively, even though power is supplied to the power domain 403, the processor 126 is in a low-power mode or a sleep mode, thereby reducing power consumption. The power domain 401 supplying power to hardware required for activation word recognition may always supply power. Further, until the speech activity is detected by the speech detection unit 122, the audio processor 125 is in the low-power mode or the sleep mode, thereby reducing power consumption. When the speech activity is detected by the speech detection unit 122, the audio processor 125 is activated and performs the preprocessing operation and the activation word recognition operation by using the speech data stored in the local memory 124.

According to various embodiments, a speech recognition device (for example, the speech recognition device 120 in FIG. 3 or 4) may comprise an MIC interface (for example, the MIC interface 121 in FIG. 4) configured to receive an audio signal; a speech detection unit (for example, the VAD unit 122 in FIG. 4) configured to detect whether the audio signal is a speech signal spoken by the user; a memory (for example, the memory 124 in FIG. 4) configured to store the audio signal; a processor (for example, the processor 126 in FIG. 4) configured to perform natural language processing; and an audio processor (for example, the audio processor 125 in FIG. 4).

According to various embodiments, the audio processor is configured to receive a speech detection signal from the speech detection unit, preprocess the audio signal stored in the memory, determine whether the preprocessed audio signal contains an activation word, generate a signal for activating the processor, when the audio signal contains the activation word and transmit, to the processor, the audio signal that is input after the audio signal containing the activation word.

According to various embodiments, the MIC interface, the speech detection unit, the memory, and the audio processor are provided in a first power domain, and the processor is provided in a second power domain that is different from the first power domain. Furthermore, when the audio processor determines that the audio signal contains the activation word, the audio processor is configured to generate a signal for supplying power to the second power domain so as to activate the processor

According to various embodiments, when the audio processor determines that the audio signal contains the activation word, the audio processor is configured to transmit, to the processor, a notification signal notifying that the activation word is recognized.

According to various embodiments, when the audio processor receives the speech detection signal from the speech detection unit, the audio processor is configured to load a program for preprocessing the audio signal to preprocess the audio signal and load a program for recognizing the activation word to determine whether the preprocessed audio signal contains the activation word.

According to various embodiments, the program for preprocessing the audio signal and the program for recognizing the activation word are stored in an external memory and the audio processor is configured to load, from the external memory, the program for preprocessing the audio signal and the program for recognizing the activation word.

According to various embodiments, the program for preprocessing the audio signal and the program for recognizing the activation word are programs based on an artificial neural network in which a learning model and a filter coefficient are determined by learning in advance.

According to various embodiments, the audio processor may have a built-in command random-access memory (RAM) storing an activation word recognition application code and a built-in data RAM storing activation word recognition application data, and the audio processor may be configured to load, from the external memory, the learning model and the filter coefficient of the artificial neural network for the program for preprocessing the audio signal and the program for recognizing the activation word, may store the learning model and the filter coefficient in the memory, and may execute the programs.

According to various embodiments, in order to load the learning model and the filter coefficient of the artificial neural network, the audio processor may be configured to stop a low-power mode of a PHY controlling a DDR DRAM which is the external memory, stop a self-refresh mode of the DDR DRAM; may read the learning model and the filter coefficient of the artificial neural network from the DDR DRAM, store, in the memory, the learning model and the filter coefficient of the artificial neural network; may set the self-refresh mode of the DDR DRAM and set the PHY to be in the low-power mode.

According to various embodiments, the speech recognition device may further comprise a communication unit. The processor may be configured to transmit the audio signal received from the audio processor, to an external natural language processing server through the communication unit, receive a result of recognition from the natural language processing server to perform the natural language processing and perform an operation corresponding to the result of recognition.

According to various embodiments, an electronic device (for example, the electronic device 100 in FIG. 3) may include: an user interface (for example, the user interface 110 in FIG. 3) configured to receive a command from a user and providing operation information to the user, a speech recognition device (for example, the speech recognition device 120 in FIG. 3) configured to recognize a command from speech of the user, a driving unit (for example, the driving unit 140 in FIG. 3) configured to perform mechanical and electrical operations to operate the electronic device, a processor (for example, the processor 130 in FIG. 3) operatively connected to the user interface, the speech recognition device, and the driving unit, and a memory (for example, the memory 150 in FIG. 3) operatively connected to the processor and the speech recognition device.

According to various embodiments, the speech recognition device may be the above-described speech recognition device, and the memory may be configured to store a program for preprocessing an audio signal and a program for recognizing an activation word, the programs being used in the speech recognition device.

According to various embodiments, on the basis of the command received from the user interface or the speech recognition device, an operation of the electronic device may be set and/or an operation of the driving unit may be controlled.

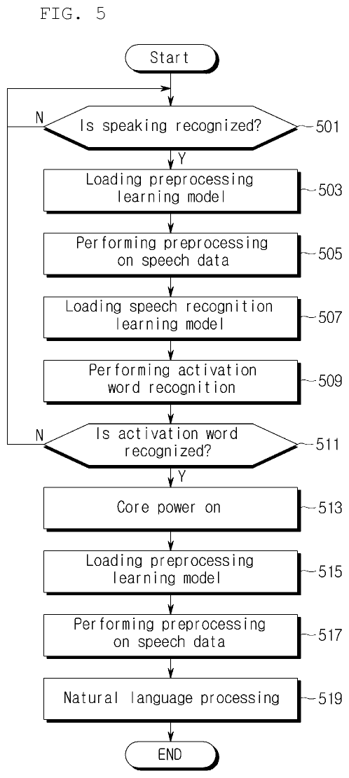

FIG. 5 is a flowchart illustrating a process in which the speech recognition device 120 recognizes speech, according to various embodiments. The process according to the flowchart shown in FIG. 5 may be implemented by a speech recognition device (for example, the speech recognition device 120 in FIG. 3) or at least one processor (for example, the processor 126 or the audio processor 125 in FIG. 4) of a speech recognition device.

Referring to FIG. 5, at step 501, the speech recognition device 120 may recognize speaking. According to an embodiment, the speech recognition device 120 may receive audio from the microphones 101 and 102 through the MIC interface 121, and may determine, by using the speech detection unit 122, whether the received audio is speech spoken by a person. When it is determined that the speech activity is detected, the speech detection unit 122 transmits the corresponding signal to the audio processor 125, and on the basis of this activity signal, the audio processor 125 may recognize speaking.

According to various embodiments, at step 503, the audio processor 125 of the speech recognition device 120 may load a preprocessing learning model for removing the noise and the echo signal contained in the speech data. In order to minimize power consumption, the speech recognition device 120 may use a memory in size as small as possible, so all programs for speech recognition may not be stored and executed. Therefore, the speech recognition device 120 may load only the required program for use, among programs required for speech recognition which are stored in an external memory (for example, the memory 150 in FIG. 3). The preprocessing learning model may be a model in which learning is performed in advance on the basis of the artificial neural network structure shown in FIG. 1.

At step 505, in the speech recognition device 120, the audio processor 125 loading the preprocessing learning model may preprocess the received speech data.

After preprocessing is completed, the speech recognition device 120 may load a speech recognition learning model to the audio processor 125 at step 507. Herein, the speech recognition learning model may be a model based on the deep learning network shown in FIG. 3 only for activation word recognition, or may be a model in which learning is performed in advance. For example, it may be a model in which the deep learning network shown in FIG. 3 learns the activation word “Hi, LG” spoken by various people as learning data.

At step 509, in the speech recognition device 120, the audio processor 125 loading the speech recognition learning model may perform activation word recognition. At step 511, the speech recognition device 120 may determine whether the activation word is recognized. When the activation word is not recognized (for example, 511-N), proceeding back to step 501 takes place and the speech recognition device 120 waits for the next speaking. When the activation word is recognized (for example, 511-Y), the speech recognition device 120 supplies power to the power domain supplying power to the processor 126 and thus activates the processor 126 at step 513. The audio processor 125 of the speech recognition device 120 may further transmit a signal indicating that the activation word is recognized, to the processor 126.

At step 515, the audio processor 125 of the speech recognition device 120 may load the preprocessing learning model again, and at step 517, the audio processor 125 may recognize the activation word, and may then perform preprocessing on the received speech data. The audio processor 125 may transmit the preprocessed speech data to the processor 126.

At step 519, the processor 126 of the speech recognition device 120 performs natural language processing on the preprocessed speech data, thereby recognizing the user's command. According to an embodiment, natural language processing may be performed by the external NLP server 200. In this case, the processor 126 may transmit the preprocessed speech data to the external NLP server 200, and may receive a result of recognition from the NLP server 200, so that the processor 126 may perform an operation corresponding to the result of recognition. According to an embodiment, the processor 126 may transmit a setting command according to the result of recognition to the electronic device 100, so that the electronic device 100 may perform the corresponding setting.

To reduce power consumption, in the above-described operation, power may not be supplied to the power domain 403 that supplies power to the processor 126, until the activation word is recognized at step 511. After the activation word is recognized at step 511, power may be supplied to the power domain that supplies power to the processor 126, at step 513.

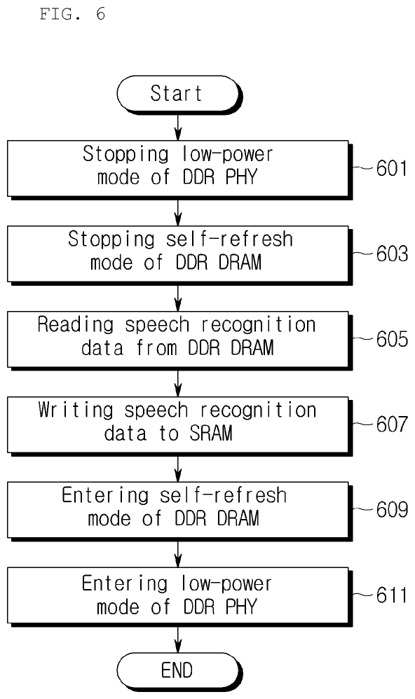

FIG. 6 is a flowchart illustrating a process in which the speech recognition device 120 loads a learning model from an external memory at step 503, 505, or 515, according to various embodiments. The process according to the flowchart shown in FIG. 6 may be implemented by a speech recognition device (for example, the speech recognition device 120 in FIG. 3) or at least one processor (for example, the processor 126 or the audio processor 125 in FIG. 4) of a speech recognition device.

In the flowchart of FIG. 6, the external memory 150 is a DDR DRAM and the local memory 124 is an SRAM, but they are not limited thereto, and other types of memory may be used.

Referring to FIG. 6, at step 601, a low-power mode of a DDR PHY controlling the DDR DRAM in the speech recognition device 120 may be stopped. Accordingly, the speech recognition device 120 may perform reading from and writing to the DDR DRAM.

At step 603, the speech recognition device 120 may stop a set self-refresh mode, so as to keep data stored in the DDR DRAM.

At step 605, the speech recognition device 120 may read a speech recognition program stored in the DDR DRAM, for example, the preprocessing learning model for audio signal preprocessing or the speech recognition learning model.

At step 607, the speech recognition device 120 may store the speech recognition program read from the DDR DRAM, in the internal memory 124, for example, an SRAM.

After the program stored in the external memory is loaded to the internal memory at steps 605 and 607, the speech recognition device 120 may set the DDR DRAM to operate in the self-refresh mode at step 609, and may set the DDR PHY to enter the low-power mode at step 611, thereby reducing power consumption.

According to various embodiments, a method of operating a speech recognition device (for example, the speech recognition device 120 in FIG. 3 or 4) may comprise receiving an audio signal; storing the audio signal in a memory, detecting whether the audio signal is a speech signal spoken by a user, when the audio signal is the speech signal spoken by the user, preprocessing, by an audio processor, noise and an echo in the audio signal stored in the memory, determining, by the audio processor, whether the preprocessed audio signal contains an activation word, activating a processor for natural language processing, when the preprocessed audio signal contains the activation word, and performing, by the processor, natural language processing on the audio signal that is received after the audio signal containing the activation word.

According to various embodiments, the activating of the processor may comprise supplying power to a second power domain in which the processor is provided, the second power domain being different from a first power domain in which the audio processor is provided.

According to various embodiments, the activating of the processor may further comprise transmitting, by the audio processor, a notification signal notifying that the activation word is recognized, to the processor.

According to various embodiments, the preprocessing of the noise and the echo in the audio signal may comprise loading a program for preprocessing the audio signal; and preprocessing, on the basis of the loaded program, the noise and the echo in the audio signal. The determining of whether the audio signal contains the activation word may comprise loading a program for recognizing the activation word; and determining, on the basis of the loaded program, whether the audio signal contains the activation word.

According to various embodiments, the loading of the program for preprocessing the audio signal may comprise loading, from an external memory, the program for preprocessing the audio signal. The loading of the program for recognizing the activation word may include: loading, from the external memory, the program for recognizing the activation word.

According to various embodiments, the program for preprocessing the audio signal and the program for recognizing the activation word may be programs based on an artificial neural network in which a learning model and a filter coefficient are determined by learning in advance.

According to various embodiments, the loading of the program for preprocessing the audio signal or the loading of the program for recognizing the activation word may comprise stopping a low-power mode of a PHY controlling a DDR DRAM which is the external memory, stopping a self-refresh mode of the DDR DRAM; reading, from the DDR DRAM, the learning model and the filter coefficient of the artificial neural network for the program for preprocessing the audio signal or the program for recognizing the activation word, storing, in the memory, the learning model and the filter coefficient of the artificial neural network; setting the self-refresh mode of the DDR DRAM, and setting the PHY to be in the low-power mode.

According to various embodiments, the performing of the natural language processing may comprise transmitting, to an external natural language processing server, the audio signal that is received after the audio signal containing the activation word, receiving a result of recognition from the natural language processing server, and performing an operation corresponding to the result of recognition.

As described above, the device and the method provided according to the present disclosure reduces power consumption in a speech recognition device using an artificial intelligence technology, thereby satisfying industrial and user demands for producing low-power products.

Although a preferred embodiment of the present disclosure has been described for illustrative purposes, those skilled in the art will appreciate that various modifications, additions and substitutions are possible, without departing from the scope and spirit of the invention as disclosed in the accompanying claims.

What is claimed is:

1. A speech recognition device comprising:
an MIC interface configured to receive an audio signal;
a speech detection unit configured to detect whether the audio signal is a speech signal spoken by a user;
a memory configured to store the audio signal;
a processor configured to perform natural language processing; and
an audio processor,
wherein the audio processor is configured to:
receive a speech detection signal from the speech detection unit,
preprocess the audio signal stored in the memory,
determine whether the preprocessed audio signal contains an activation word,
generate a signal for activating the processor, when the audio signal contains the activation word and
transmit, to the processor, the audio signal that is input after the audio signal containing the activation word.

2. The speech recognition device of claim 1, wherein the MIC interface, the speech detection unit, the memory, and the audio processor are provided in a first power domain, and the processor is provided in a second power domain that is different from the first power domain, and
when the audio processor determines that the audio signal contains the activation word, the audio processor is configured to generate a signal for supplying power to the second power domain so as to activate the processor.

3. The speech recognition device of claim 2, wherein when the audio processor determines that the audio signal contains the activation word, the audio processor is configured to transmit, to the processor, a notification signal notifying that the activation word is recognized.

4. The speech recognition device of claim 1, wherein when the audio processor receives the speech detection signal from the speech detection unit, the audio processor is configured to load a program for preprocessing the audio signal to preprocess the audio signal and load a program for recognizing the activation word to determine whether the preprocessed audio signal contains the activation word.

5. The speech recognition device of claim 4, wherein the program for preprocessing the audio signal and the program for recognizing the activation word are stored in an external memory, and
the audio processor is configured to load, from the external memory, the program for preprocessing the audio signal and the program for recognizing the activation word.

6. The speech recognition device of claim 5, wherein the program for preprocessing the audio signal and the program for recognizing the activation word are programs based on an artificial neural network in which a learning model and a filter coefficient are determined by learning in advance.

7. The speech recognition device of claim 6, wherein the audio processor has a built-in command random-access memory (RAM) storing an activation word recognition application code and a built-in data RAM storing activation word recognition application data, and
the audio processor is configured to load, from the external memory, the learning model and the filter coefficient of the artificial neural network for the program for preprocessing the audio signal and the program for recognizing the activation word, store the learning model and the filter coefficient in the memory, and execute the programs.

8. The speech recognition device of claim 7, wherein in order to load the learning model and the filter coefficient of the artificial neural network, the audio processor is configured to stop a low-power mode of a PHY controlling a DDR DRAM which is the external memory, stop a self-refresh mode of the DDR DRAM, read the learning model and the filter coefficient of the artificial neural network from the DDR DRAM, store, in the memory, the learning model and the filter coefficient of the artificial neural network, set the self-refresh mode of the DDR DRAM and set the PHY to be in the low-power mode.

9. The speech recognition device of claim 1, further comprising:
a communication unit,
wherein the processor is configured to transmit the audio signal received from the audio processor, to an external natural language processing server through the communication unit, receive a result of recognition from the natural language processing server to perform the natural language processing and perform an operation corresponding to the result of recognition.

10. An electronic device comprising:
a user interface configured to receive a command from a user and providing operation information to the user;
a speech recognition device configured to recognize a command from speech of the user;
a driving unit configured to perform mechanical and electrical operations to operate the electronic device;
a processor operatively connected to the user interface,
the speech recognition device, and the driving unit; and
a memory operatively connected to the processor and the speech recognition device,
wherein the speech recognition device is a speech recognition device of any one of claims 1 to 8, and
the memory is configured to store a program for preprocessing an audio signal and a program for recognizing an activation word, the programs being used in the speech recognition device.

11. The electronic device of claim 10, wherein the processor is configured to set an operation of the electronic device and/or controls an operation of the driving unit, based on the command received from the user interface or the speech recognition device.

12. A method of operating a speech recognition device, the method comprising:
receiving an audio signal;
storing the audio signal in a memory;
detecting whether the audio signal is a speech signal spoken by a user;
when the audio signal is the speech signal spoken by the user,
preprocessing, by an audio processor, noise and an echo in the audio signal stored in the memory;
determining, by the audio processor, whether the preprocessed audio signal contains an activation word;
activating a processor for natural language processing, when the preprocessed audio signal contains the activation word; and
performing, by the processor, natural language processing on the audio signal that is received after the audio signal containing the activation word.

13. The method of claim 12, wherein the activating of the processor comprises:
supplying power to a second power domain in which the processor is provided, the second power domain being different from a first power domain in which the audio processor is provided.

14. The method of claim 13, wherein the activating of the processor further comprises:
transmitting, by the audio processor, a notification signal notifying that the activation word is recognized, to the processor.

15. The method of claim 12, wherein the preprocessing of the noise and the echo in the audio signal comprises:
loading a program for preprocessing the audio signal; and
preprocessing, on the basis of the loaded program, the noise and the echo in the audio signal, and
the determining of whether the audio signal contains the activation word comprises:
loading a program for recognizing the activation word; and
determining, on the basis of the loaded program, whether the audio signal contains the activation word.

16. The method of claim 15, wherein the loading of the program for preprocessing the audio signal comprises:
loading, from an external memory, the program for preprocessing the audio signal, and
the loading of the program for recognizing the activation word comprises:
loading, from the external memory, the program for recognizing the activation word.

17. The method of claim 16, wherein the program for preprocessing the audio signal and the program for recognizing the activation word are programs based on an artificial neural network in which a learning model and a filter coefficient are determined by learning in advance.

18. The method of claim 17, wherein the loading of the program for preprocessing the audio signal or the loading of the program for recognizing the activation word comprises:
stopping a low-power mode of a PHY controlling a DDR DRAM which is the external memory,
stopping a self-refresh mode of the DDR DRAM;
reading, from the DDR DRAM, the learning model and the filter coefficient of the artificial neural network for the program for preprocessing the audio signal or the program for recognizing the activation word;
storing, in the memory, the learning model and the filter coefficient of the artificial neural network;
setting the self-refresh mode of the DDR DRAM; and
setting the PHY to be in the low-power mode.

19. The method of claim 12, wherein the performing of the natural language processing comprises:
transmitting, to an external natural language processing server, the audio signal that is received after the audio signal containing the activation word;
receiving a result of recognition from the natural language processing server; and
performing an operation corresponding to the result of recognition.
